(19) United States
(12) Patent Application Publication
(10) Pub. No.: US 2018/0043563 A1
(43) Pub. Date: Feb. 15, 2018

(54) Cutting Unit Comprising a Blade For Cutting at Least One Fiber, Particularly For Producing Fiber Preforms

(71) Applicants: VOITH PATENT GMBH, HEIDENHEIM (DE); AUDI AG, NGOLSTADT (DE)

(72) Inventors: JAROMIR UFER, MUENCHEN (DE); MICHAEL KAISER, KIRCHSEEON (DE); MANFRED BURKHARD, DIESSEN/ OT DETTENSCHWANG (DE); SEBASTIAN GIERL, AUGSBURG (DE)

(21) Appl. No.: 15/556,217

(22) PCT Filed: Mar. 10, 2016
(86) PCT No.: PCT/EP2016/055109

§ 371 Date: Sep. 6, 2017

(30) Foreign Application Priority Data
Mar. 12, 2015 (DE) 102015204417.3

(51) Int. Cl. B26D 5/18; B26D 7/02; B26D 1/06

(52) U.S. Cl. CPC B26D 5/18; B26D 1/065; B26D 7/02; B29B 11/16

(57) ABSTRACT

A cutting unit includes a blade for cutting at least one fiber, particularly on a cutting support, and particularly for producing fiber preforms which are, in particular, a precursor in the production of fiber-reinforced plastic components. A guide device is arranged so as to guide at least one of either the blade or a cutting support which can be moved relative to the blade, along a linear path in order for cutting to take place. At least one such cutting unit is preferably used in a device for producing fiber preforms which are, in particular, a precursor in the production of fiber-reinforced plastic components. The device has at least one unwinding station for providing at least one fiber, and at least one gripper which can grip individual or a plurality of fibers at their front ends.

The invention relates to a cutting unit comprising a blade for cutting at least one fiber, in particular for producing fiber preforms which provide, in particular, a preliminary stage in the production of fiber-reinforced plastics material components. In addition, the invention relates to a device for producing fiber preforms which provide, in particular, a preliminary stage in the production of fiber-reinforced plastics material components.

DE 10 2011 007 018 A1 describes in a preferred technical area a device for producing fiber preforms which provide, in particular, a preliminary stage in the production of fiber-reinforced plastics material components. A cutting device is named for cutting off fibers.

When cutting fibers, in particular fiber bands, as a rule cutting systems where the cutting unit cuts fibers according to a scissor principle are used. In addition, there are systems comprising a cutting unit which carries out the cutting using knives which are fastened on a roller and penetrate into a soft counter roller. If a repeated cutting operation is required, where it is necessary to open the cutting unit wide between cutting operations, e.g. to reach through for transporting a fiber material, the existing systems can only be used in a limited manner. In particular, where there is very little installation space available, it is technically very expensive to design conventional cutting systems in such a way that a cutting unit, in particular the blade thereof, is able to be opened in a sufficiently wide manner.

Consequently, it is the object of the invention to provide a modified cutting unit which, in particular with simple kinematics, enables a reliable cutting operation and a sufficiently large opening. A device for producing fiber preforms with a modified cutting unit is also to be provided.

The solution according to the invention is characterized by the features of claim 1 or 11. Advantageous designs are reproduced in the subclaims.

Preferred is, accordingly, a cutting unit comprising a blade for cutting at least one fiber in particular on a cutting base, in particular for producing fiber preforms which provide, in particular, a preliminary stage in the production of fiber-reinforced plastics material components, wherein a guide device is arranged to guide at least either of the blade or a cutting base, which is movable relative to the blade, along a linear path for cutting.

A first variant consequently provides guiding the blade along a linear path for cutting the fiber, wherein the fiber is pressed against a cutting base during the cutting operation or, where a cutting base is not used, the fiber is tensioned in this case by means of the blade. A second variant provides that the blade is arranged, in particular, in a fixed manner and a cutting base for cutting the fiber is guided along a linear path toward the blade. According to a third variant, both the blade and a cutting base are guided along a linear path toward one another and against one another for cutting the fiber.

In particular, consequently one of the two components—blade and cutting base—is arranged in a fixed manner or both components are consequently moved along a common path.

The cutting unit is designed in a preferred manner for cutting reinforcement fibers for producing fiber-reinforced plastics material components or corresponding preforms, i.e. preliminary forms produced from a fiber composite material.

An advantage compared to scissors or cutting rollers is that as a result of the blade being guided in a linear or straight-lined manner, fibers which are arranged in particular side by side are not displaced sideways. The precise positioning of the fibers is very important to the strength of CFRP components (CFRP: carbon fiber reinforced plastic) and is advantageously made possible.

Guiding the blade in a linear manner additionally enables a cutting unit which only requires a small amount of space and is thus usable in particular for cutting reinforcement fibers in an advantageous manner in a device for producing fiber-reinforced plastics material components or corresponding preforms, in particular semi-finished fiber products. Guiding in a linear manner also allows for a large space between blade and cutting base for picking up the fibers or a band. The necessary installation space for such a cutting unit is additionally extremely small with reference to an achievable cutting force.

Fibers are also to be understood here, in particular, as multiple fibers which are arranged adjacent one another, fiber bands which comprise fibers and fiber materials. In particular, fibers are also to be understood here as yarns and so-called rovings, i.e. a strand, bundle or multi-filament yarn produced from filaments or continuous fibers arranged in parallel. Fibers are also to be understood in this case as semi-finished products, thermoplastic or thermosetting prepegs. The cutting or severing method or a corresponding cutting unit can also be used in particular in a roving applicator.

A preferred further development consists in that the linear path leads in a direction at least substantially transversely to an extension of the cutting base or to a cutting edge of the blade.

In particular, the cutting edge extends in such a manner transversely or substantially transversely to the linear path that the cutting edge is pressed with its longitudinal extension through the fibers and against and/or into the cutting base.

In particular, the linear path extends at least substantially perpendicularly to a plane spanned by the cutting base. The severing or cutting edge of the blade is guided up to the fiber in such a manner for cutting, in particular transversely or perpendicularly to the longitudinal extension of a fiber to be cut through as a result of the cutting process. In the event of a fiber arranged horizontally on the cutting base, the blade is consequently pressed from above or below against the fiber.

At least substantially transversely means that not only guiding transversely to the cutting base but, where applicable, also a deviation of a few angular degrees, in particular up to 5°, in particular up to 10° is tolerable. A more inclined portion of the band is advantageous with reference to wastage. A more inclined cut from above or in the cut longitudinal direction with such a tolerance can be advantageous technically for reasons of installation space.

A preferred further development consists in that the cutting base is realized from a soft material or at least comprises a soft surface.

The opposite side of the blade consequently provides a soft cutting base, e.g. a PU material (PU: polyurethane). A soft or yielding surface enables a cutting principle with the blade on a soft cutting base, wherein the blade or the cutting edge thereof consists of a material that is rigid relative to the base. This results, when the blade is pressed onto the fiber, in filaments of the fiber to be cut through breaking and thus enables effective and reliable cutting which is sufficiently tolerant in particular also in the case of a blunt blade.

A preferred further development consists in that the blade and/or the cutting base is fixed so as to be adjustable in relation to a fastening point by means of a drive arrangement and the guide device guides a component of the drive arrangement, which is adjustable between the fastening point and the blade and/or the cutting base, in such a manner along a guide path with a predetermined path progression that the blade and/or the cutting base is adjustable only along the linear path.

A fastening point, in this case, is, for example, a frame of a device in which the cutting unit is inserted, in particular a fixed component part of a device for the production of fiber reinforced plastics material components or corresponding preforms. The adjustable component is, in particular, a rigid linkage element which drives the blade, a further joint which is adjustable relative to the fastening point or the blade or a blade mounting.

The guide path can have a linear progression when, for example, the blade or a joint on the blade or the blade mounting thereof is guided by the guide device. In particular, in such a case the guide path and the linear path can coincide. The guide path, however, can also have a non-linear, for example arcuate progression when, for example, an adjustable component, which is at a spacing from the joint on the blade, is guided by the guide device.

A preferred further development consists in that the adjustable component is a component part of a lever arrangement, in particular a toggle lever arrangement.

A lever arrangement provides a redirection of force as indirect drive means and thus enables a particularly small requirement for installation space. A lever arrangement preferred for this comprises a linkage and joint arrangement produced from rigid linkage elements and joints which connect them, at least one linkage element or joint realizing the adjustable component. The in particular two linkage elements are connected together in an articulated manner by a joint. A drive, for example a cylinder drive, for example a pneumatic cylinder is arranged on, in particular, one of the joints such that the components of the toggle lever arrangement are adjustable relative to one another by means of the drive. In the case of a toggle lever arrangement preferred for this, one joint is fastened on a fastening point and one joint is assigned to the blade, in particular is fastened in an articulated manner on the blade or on a blade mounting.

The guide device, in this case, is, for example, a guide unit with a guide path which guides one of the joints or the blade or the blade mounting thereof along a predetermined path progression. Where there is, in particular, lateral guiding of the joint on the blade, of the blade or of the blade mounting, the guide path runs, in particular, in a linear manner in order to bring about a linear blade path. Where there is, in particular, lateral guiding of a joint which is arranged between linkage elements, in a preferred manner the guide path runs in a non-linear manner in order to bring about a linear blade path.

In particular, such a toggle lever principle enables a very compact and easy method of construction with reference to the achievable cutting force. Thus, in a particularly preferred manner, an opening movement can be carried out quickly and with little expenditure of force, whilst a cutting movement can be carried out slowly with a high level of expenditure of force.

In particular, attaching the blade in a central and pivotably mounted manner enables the cutting forces of the blade to be distributed uniformly onto the cutting base. Even when the base deflects slightly, for example on account of limited rigidity, a cut that is more reliable is made possible. This additionally keeps any tolerance demand on a guide or the guide device very small.

A preferred further development consists in that the adjustable component is a drive element, which is adjustable in relation to the fastening point, of a drive which drives the blade and/or the cutting base directly in relation to the fastening point.

Such a drive is, for example, a drive cylinder or motor fastened on an, in particular, fixed frame of the cutting unit, for example a crank mechanism, the drive cylinder or motor being fastened, for example, directly by means of its adjustable drive element or by means of a joint to the blade or the blade mounting thereof.

The guide device, in this case, is, for example, once again a drive unit with a drive path which guides either the joint or the blade or the blade mounting thereof along a predetermined path progression. In the event of a cylinder which directly drives the blade with its piston linkage, the guide device is realizable as an option by the cylinder arrangement itself.

A preferred further development consists in that the blade and/or the cutting base is adjustable by means of a momentum drive device.

A momentum drive device is, for example, a crank mechanism or a different drive comprising, between the same and the blade, a gear unit or pivotably connected linkage in a design which accelerates the blade during the movement for cutting. The blade is accelerated and cuts off the fiber as a result of such a momentum principle.

A preferred further development consists in that the blade and/or the cutting base is adjustable by means of a pulse drive device.

A pulse drive device is, for example, a drive comprising, between the same and the blade, a gear unit or pivotably connected linkage in a design which deposits the blade on the material during the movement for cutting and cuts the fiber as a result of a pulse or impact acting on the blade.

A preferred further development consists in that a holding device is arranged on the cutting unit, in particular on a component adjusting the blade and/or the cutting base, for holding a fiber to be cut through adjacent to the blade and/or the cutting base during cutting.

As a result, the fiber can be held in particular behind the cutting unit during the cutting operation. This is designable in particular by a gripper in addition to the gripper holding the fiber or by a combined mechanism which is connected to the cutting unit. In particular, such a mechanism can comprise a spring-loaded holding-down device as the holding element.

A preferred further development consists in that a holding device is arranged on the cutting unit to hold a fiber to be cut through in a defined position during cutting and after cutting.

The defined position serves for the purpose of holding the fiber in a defined position during an in particular subsequent pick-up operation. To this end, as the holding device, in particular restoring elements such as, for example, thin spring plates can be used as the holding element in the cutting unit or adjacent to the same. In particular, the holding device fixes the fibers in the defined position on the cutting base or on a component adjacent to the same.

In particular, the above statements regarding an adjustable blade also apply correspondingly to an accordingly adjustable cutting base.

Preferred is additionally a device for producing fiber preforms which provide, in particular, a preliminary stage in the production of fiber-reinforced plastics material components, wherein the device comprises at least one unwinding station and at least one yarn transfer point for the provision of at least one fiber, and at least one gripper which can grip individual or multiple fibers at its beginning, and at least one cutting device for cutting the at least one fiber, wherein the at least one cutting device is or comprises at least one cutting unit.

In a preferred manner, the cutting units are arranged between the gripper and the receiving table or mold in devices for producing fiber preforms.

A preferred further development consists in that the device comprises multiple such unwinding stations for the provision of multiple fibers, in particular yarns or rovings, and multiple grippers which in each case can grip individual or multiple yarns or rovings at their beginning, wherein each gripper is movable to and fro along a path between a maximum position and a pick-up position, wherein the pick-up position is provided at a yarn transfer point and is closer to the unwinding station than the maximum position, wherein each gripper has an own maximum position and is assigned to an own yarn transfer point and wherein the grippers are each movable individually along paths which are substantially parallel to one another.

In a particularly preferred manner, one or multiple such cutting units will be or are used in a device, as is described, for example, in DE 10 2011 007 018 A1. The cutting device thereof, in this case, is realized by one or multiple such cutting units.

A preferred further development consists in that the at least one cutting unit for cutting the at least one fiber, yarns or rovings is arranged between a mold and the at least one gripper and/or the at least one cutting unit for cutting the at least one fiber, yarns or rovings is arranged between a mold and the at least one yarn transfer point.

Other drive forms which are operated, for example, hydraulically, electrically or electromagnetically can also be used as drive means along with the pneumatic cylinders named as an example.

Such a cutting unit or a device with such a cutting unit is advantageous compared to the scissor principle as a result of the considerably smaller installation space and as a result of the cut transversely through the fiber against the cutting base, which avoids displacing and, where applicable, compressing fibers that are adjacent one another. Compared to the scissor principle of a guillotine, the requirements for guiding the cuts are very minimal as a cutting gap, which would not be tolerable in the case of fiber material, is avoided. A cutting unit which is light and of a size that is dimensioned in a structurally compact manner is accordingly produced as a result.

The solution according to the invention is explained below by way of figures, in which in detail:

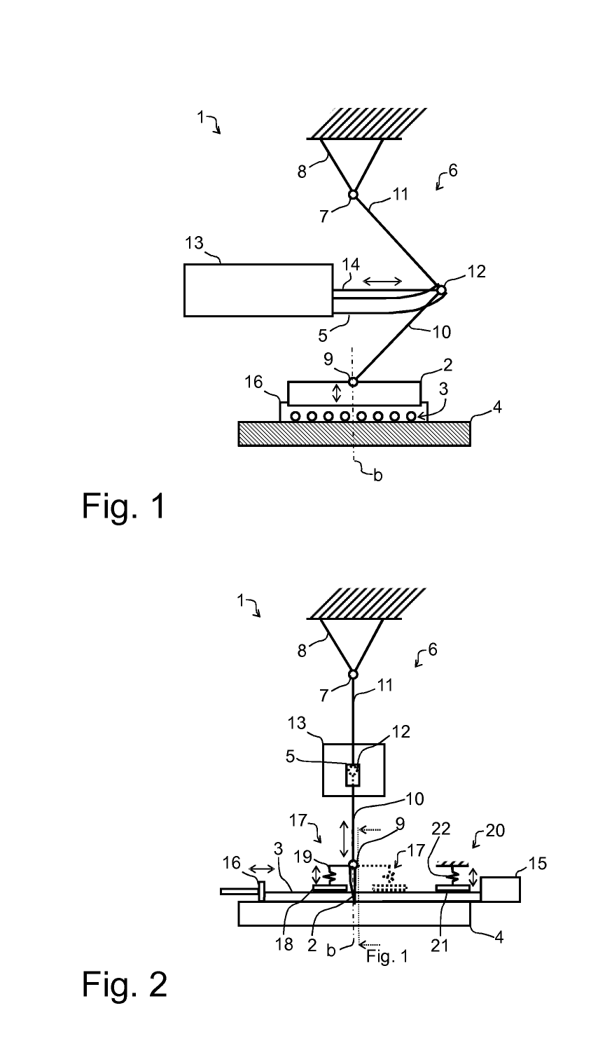

FIG. 1 shows a partially sectioned view of a schematically simplified representation of the basic structure of a cutting unit for cutting a fiber during a first operating position,

FIG. 2 shows a further side view compared to FIG. 1 of the basic structure during a second operating position,

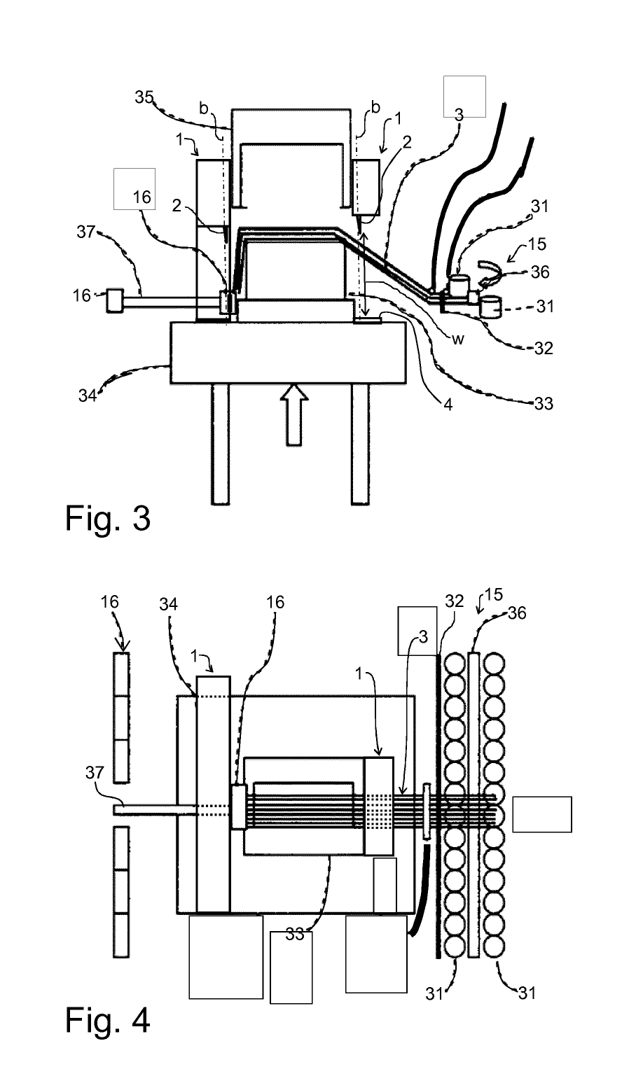

FIG. 3 shows a side view of a schematically simplified representation of a basic structure of a device for producing fiber preforms, which provide, in particular, a preliminary stage in the production of fiber-reinforced plastics material components,

FIG. 4 shows a top view of the basic structure of the device from FIG. 3,

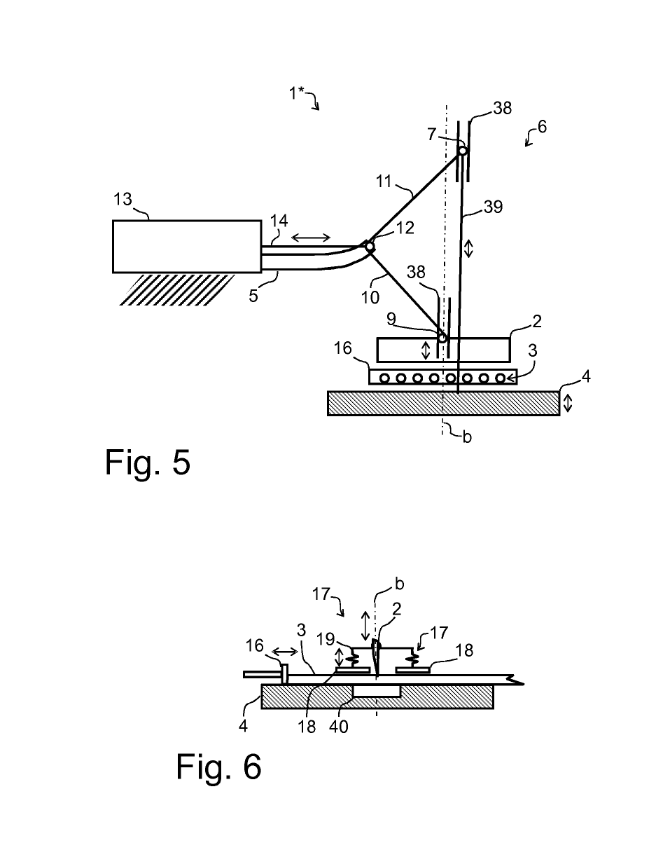

FIG. 5 shows a partially sectioned view of a schematically simplified representation of a basic structure, modified in relation to FIG. 1, of a cutting unit for cutting a fiber during a first operating position and

FIG. 6 shows a schematized representation of a detail of a basic structure according to FIG. 2 with a modified cutting base.

FIGS. 1 and 2 show a cutting unit 1 with a blade 2 for cutting a fiber 3 or a plurality of such fibers 3. FIG. 1 shows a first operating position prior to cutting with the blade 2 above the fiber 3. FIG. 2 shows a second operating position during or after cutting with the blade 2 in the fiber 3.

A cutting base 4 is arranged underneath the blade 2. The cutting base 4 extends in a plane which is arranged parallel or substantially parallel to a cutting edge of the blade 2. The blade 2 is arranged so as to be adjustable along a linear path b for cutting through the fibers 3. The linear path b runs transversely or substantially transversely to the longitudinal extension of the cutting edge or perpendicularly or substantially perpendicularly to the extension of the plane of the cutting base 4.

The cutting unit 1 comprises a fastening point 8, in particular a fixed point which is stationary in relation to the cutting base 4 and/or in relation to a frame. The blade 2 is mounted so as to be adjustable in relation to the fastening point 8 by means of a drive arrangement.

A lever arrangement, in particular a toggle lever arrangement 6, is shown as an example of a drive arrangement. It consists of a joint 7, by means of which a linkage element 11 is pivotably connected to the fastening point 8. A further linkage element 10 is pivotably connected to the oppositely situated end of the linkage element 11 by means of a further joint 12. The blade 2 is pivotably connected to the oppositely situated end of the further linkage element 10 by means of yet another joint 9.

A guide device 5 is arranged in such a manner on the cutting unit 1 in the region of the drive arrangement that an adjustment of the components of the drive arrangement, that is to say, in particular, of the joints 7, 9, 12 and of the linkage elements 10, 11, is possible only such that the blade 2 is adjustable in particular only along the linear path b.

In the case of the toggle lever arrangement 6 shown, the guide device 5 comprises a guide path which, for example, guides a bolt which protrudes laterally in the region of the central joint 12. The guide path comprises, in this case, a non-linear, in particular arcuate progression.

The cutting unit 1 additionally comprises a drive 13 which is realized, for example, as a pneumatic cylinder. A linkage 14, which is adjustably drivable by means of the drive 13, is connected to the central joint 12 in such a manner that, by means of the drive 13, the blade 2 with its cutting edge is adjustable in the direction of the cutting base 4 or in the opposite direction via the toggle lever arrangement 6.

In a particularly preferred manner, by means of the toggle lever principle, an opening movement can be carried out quickly and with little force expended, whilst a cutting movement can be carried out slowly and with a large amount of force expended. According to a preferred method of control, the drive 13 is actuated correspondingly in such a manner that an opening movement, that is to say an adjustment of the blade 2 away from the cutting base 4, is actuated quickly, whilst a cutting movement in the opposite direction is actuated slowly.

A gripper 16 serves for transporting the fibers 3.

FIG. 2 additionally shows a yarn pick-up point 15 which comprises, in particular, an unwinding station and a yarn transfer point for providing at least one such fiber 3. The gripper 16, which is adjustable in and counter the direction to the yarn pick-up point 15 and is realized to receive at least one fiber 3 at the yarn transfer point and to pull it over an operating region, is outlined situated opposite. In this case, the cutting unit 1 is situated in such a manner over the operating region that the at least one fiber 3 can be cut through by means of the blade 2.

A holding device 17, which is designed to hold the fiber 3 adjacent the blade 2 during the cutting-through process by way of a holding element 18, is additionally outlined. A further position of the holding device 17 as an example is outlined by a dotted line. As an example, the holding element 18 is connected by means of an, in particular, elastic connecting mechanism 19 to a component which adjusts the blade 2. Before the blade 2 reaches the fiber 3, the holding element 18 clamps the fiber 3 against the cutting base 4. On account of the elasticity of the connecting mechanism 19, the blade 2 can be adjusted further in the direction of the cutting base 4 in order to cut through the fiber 3.

In a preferred manner, the cutting base 4 is realized from a soft or elastic material and enables the cutting edge of the blade 2 to press-in the surface of the cutting base 4 somewhat or to penetrate somewhat into the surface of the cutting base 4.

A further holding device 20, which holds the at least one fiber 3 in particular adjacent to the yarn pick-up point 15 for a pick-up operation, is additionally outlined. A holding element 21 is fastened by means of an, in particular, elastic connecting mechanism 22 on or opposite the operating region and/or the cutting base 4 in such a manner that the at least one fiber 3 is able to be held sufficiently firmly.

FIGS. 3 and 4 show a device 30 for producing fiber preforms which, in particular, provide a preliminary stage in the production of fiber-reinforced plastics material components, according to 10 2011 007 018 A1. Insofar as components and functions which are described in FIG. 1 or 2 are used, in particular also by way of reference symbols, corresponding statements with regard to the components and functions are applicable in FIGS. 3 and 4.

The fibers 3, in particular yarns or rovings, are provided by means of a plurality of unwinding stations 31, in which the fiber material is provided in the form of spools or balls of yarn (so-called bobbins). The unwinding stations 31 are arranged in several rows side by side, one behind another or one above another. The beginnings of the fibers 3 are shown schematically only in the region in use in each case for the unwinding stations 31 in use. All these other beginnings of fibers 3 are threaded to corresponding yarn transfer points 32 such that they can be grasped by the associated grippers 16 in assigned pick-up positions. Such an arrangement is designated together as a creel.

On the other side, the grippers 16, apart from one gripper 16, are shown in their maximum positions, which, in this case, also correspond to the start positions. Even if only grippers 16 of identical widths are shown, grippers 16 with different widths which can grip, in particular, a correspondingly other number of fibers 3, are also possible. The grippers 16 do not necessarily also have to have their maximum and pick-up positions in a line. In addition, a first mold 33 is shown on a table, in particular a lifting table 34, and a second mold 35, which is realized as a hood, is shown in the removal position, that is to say outside the path of the grippers 16. The second mold 35 is not shown in FIG. 4. A corresponding moving or lowering device for the second mold 35 is not shown either. In addition, there is a binder material supply 36, which is arranged, for example, between the rows of unwinding stations 31.

One of the grippers 16 is situated in the pick-up position and fetches the fibers 3 corresponding to its arrangement in the device by gripping the beginnings thereof. The gripper 16 is displaceable by means of a guide device 37, for example a linkage or a piston. The grippers 16 are moveable individually between the pick-up position and the maximum position, but in particularly only linearly and side by side along parallel paths. This enables simple automation and quick parallel movement. As shown, multiple unwinding stations 31 can be combined to form a group and can be assigned to one gripper 16. In a preferred manner, there are at least as many unwinding stations 31 as grippers 16.

Binder material 18, for example in the form of binder fibers or binder non-woven fabrics, can also be clamped by the gripper 16 together with the fibers 3, in particular yarns or rovings.

The device is shown after a first draping stage of a first layer produced from fibers 3 or yarns or rovings. The first mold 33 has been moved into the draping position by the lifting table 34. As a result, the fibers 3 are deflected and draped over the mold 33. The gripper 16 fixes the beginnings of the fibers 3 close to the outside contour of the mold 33. After said stage, as an alternative to this or in addition to it, binder material can be applied or sprayed onto the fibers 3. In the next stage, the fibers 3 are draped further or shaped by means of the second mold 35, which has been moved into its draping position. Precise shaping is possible as a result of the interaction between the two molds 33, 35 between which the layer of fibers 3 is situated.

At the same time as or after fixing, the fibers 3 are cut on both sides of the molds by means of a cutting device, that is to say between gripper 16 and mold 33 or 35 and between yarn transfer points 32 and mold 33 or 35. In one embodiment, the cutting device can be connected to the first or second mold. It is advantageous when the cut is effected close to the mold 33 at least on the side of the yarn transfer points 32. As a result, little wastage of expensive fiber material occurs and less post-processing of the fiber preform is necessary.

As an example, two cutting units 1, described here, in particular according to FIGS. 1 and 2, are used as cutting devices in said device 30. The cutting unit outlined on the left-hand side of the cutting units 1 is fastened, for example, on the lifting table 34. The cutting unit outlined on the right-hand side of the cutting units 1 is fastened, for example, on the upper mold 35. A large opening width w or lift height between the blade 2 and the cutting base 4, with the cutting unit 1 having at the same time a small lateral extension and a small installation height, can be seen in FIG. 3.

The cut fibers 3 can be pulled back again and wound by means of a rewinding device or can be stored temporarily by means of corresponding yarn guiding. The rewinding is effected such that once again beginnings of the fibers 3 lie in the region of the yarn transfer points 32 such that they are able to be picked up by the grippers 16 without there being too much wastage material. It is possible to use sensors for detecting the beginnings. The holding device 20 for the pick-up operation from FIGS. 1 and 2 can also be used in place of or in addition to such rewinding devices.

Using such a device, it is also possible to carry out, in particular, a method for producing fiber preforms, which, for example, provide a preliminary stage in the production of fiber-reinforced plastics material components, said method comprising the following method stages: tensioning fibers 3, in particular yarns or rovings, draping the fibers 3 over a mold 33, fixing the draped fibers 3 to form a fiber preform, wherein multiple separate grippers 16 at multiple yarn transfer points 32, assigned in each case to the individual grippers 16, grip individual or multiple fibers 3, wherein the grippers 16 are then moved toward one another along substantially parallel paths and wherein, as a result, the fibers 3 are clamped side by side. Once the fibers 3 have been fixed by means of a further mold 35 placed thereon, the laterally protruding fibers 3 between mold 33 or 35 and gripper 16 and/or between mold 33 or 35 and yarn transfer point 32 are cut through.

A modification as an example provides that the guide device 5 is set up in a fixed manner in the arrangement and the blade is set up guided in a positively guided manner. Fixed guiding of the joint 12 in the guide path 5 is sufficient in such a case. Components arranged above this in the drawing in FIG. 1, such as the fastening point 8, the linkage 11 and the joint 7, can be omitted. Further modifications can provide a different component or another two different components as fixed fastening points.

According to various designs, only the cutting base is moved toward the fiber and the blade or only the blade is moved toward the fiber or both, i.e. blade and cutting base, are moved toward one another and in this case, both are also moved toward the fiber that is located in between.

FIG. 5 shows a partially sectioned view of a schematized simplified representation of a basic structure, modified in relation to FIG. 1, of a cutting unit 1* for cutting a fiber during a first operating position. In particular, differences compared to FIG. 1 will be described below with reference to the statements concerning FIG. 1.

As an example, the drive 13 and the guide device 5 are arranged in a fixed manner in the overall arrangement. The blade 2 is guided in a positively guided guide 38.

The components arranged on the other side of the joint 12 when seen from the blade 2, such as the fastening point 8, the linkage 11 and the joint 7, are arranged with a further linkage 39 for adjusting the cutting base 4 such that the blade 2 and the cutting base 4 are moved along the linear path b in a reciprocal manner, i.e. toward one another or away from one another. Moved along the linear path b is to be understood in this case once again as the blade 2 with its cutting edge being guided so as to be movable transversely or substantially transversely to the fiber 3 and the cutting base 4 with its extension parallel in particular to the cutting edge of the blade 2 being guided so as to be movable transversely or substantially transversely to the fiber 3.

The linkage 39 is fastened on the joint 7 for example and extends along or implicitly also parallel to the linear path b to the cutting base 4, on which the linkage 39 is fixedly or pivotably fastened by way of, in particular, its oppositely situated end. In a preferred manner, in this case, the joint 37 or the cutting base 4 is guided in a further guide 38, the guide 38 guiding the further linkage 39 and/or the cutting base 4 along the linear path b.

FIG. 6 shows a schematized representation of a detail of a basic structure according to FIG. 2 with a modified cutting base 4. A recess 40 is realized in the cutting base 4. The recess 40 leads into the cutting base 4 in the region in which the blade 2 contacts the upper plane of the cutting base 4 when cutting.

In order to be able to cut through the fiber 3, two holding elements 18, in particular, are arranged for tensioning the fiber 3 against a surface of the cutting base 4 adjacent to the recess 40. In particular, such holding elements 18 are connected elastically to the blade 2 by means of one or in each case one holding device 17 or are connected to the blade 2 by means of one or in each case one, in particular, elastic connecting mechanism 19. The blade 2 is guidable through the fiber 3 between the holding elements 18.

Further modifications provide, in particular, combinations of the design elements alternatively described above. Thus, for example, the holding devices can be arranged alternatively or additionally on the cutting base which is adjustable, in particular, along the path.

### LIST OF REFERENCES

1; 1* Cutting unit
2 Blade
3 Fiber
4 Cutting base
5 Guide device
6 Drive arrangement, in particular toggle lever arrangement
7 Joint
8 Fastening point
9 Joint
10 Linkage
11 Linkage
12 Joint
13 Drive
14 Linkage
15 Yarn pick-up point, in particular unwinding station
16 Gripper, adjustably drivable
17 Holding device
18 Holding element
19 Connecting mechanism
20 Holding device
21 Holding element
22 Connecting mechanism
30 Device for producing fiber preforms
31 Unwinding stations
32 Yarn transfer points
33 First mold
34 Lifting table
36 Binder material supply
37 Guide device
38 Guides
39 Linkage on cutting base
40 Recess
b Linear path
w Opening width or lifting height of the blade

1-13. (canceled)

14. A cutting unit, comprising:
a blade for cutting at least one fiber;
a cutting base;
wherein said blade and said cutting base are movable relative to one another; and
a guide device configured to guide at least one of said blade or said cutting base along a linear path for cutting.

15. The cutting unit according to claim 14, wherein said blade is configured for cutting fibers of fiber preforms being a preliminary stage in the production of fiber-reinforced plastics material components.

16. The cutting unit according to claim 14, wherein the linear path extends in a direction substantially transverse to an extension of said cutting base or to a cutting edge of said blade.

17. The cutting unit according to claim 14, wherein said cutting base is formed of a soft material or is formed with a soft surface so as to enable said blade to dive into the surface of said cutting base.

18. The cutting unit according to claim 14, wherein said blade and/or said cutting base is fixed so as to be adjustable in relation to a fastening point by way of a drive arrangement and said guide device is configured to guide a component of the drive arrangement, which is adjustable between the fastening point and said blade and/or said cutting base, in such a manner along a guide path with a predetermined path progression that said blade and/or said cutting base is adjustable only along the linear path.

19. The cutting unit according to claim 18, which comprises a lever arrangement and wherein the adjustable component is a component part of said lever arrangement.

20. The cutting unit according to claim 18, wherein said lever arrangement is a toggle lever arrangement.

21. The cutting unit according to claim 18, which comprises a drive configured to drive said blade and/or the cutting base directly in relation to the fastening point, and wherein the adjustable component is a drive element that is adjustable in relation to the fastening point, and said drive element is a component of said drive for driving said blade and/or said cutting base.

22. The cutting unit according to claim 14, which comprises a momentum drive device for adjusting said blade and/or said cutting base.

23. The cutting unit according to claim 14, which comprises a pulse drive device for adjusting said blade and/or said cutting base.

24. The cutting unit according to claim 14, which comprises a holding device configured to hold the at least one fiber to be cut adjacent said blade and/or said cutting base during cutting.

25. The cutting unit according to claim 24, wherein said holding device is disposed on a component for adjusting said blade and/or said cutting base.

26. The cutting unit according to claim 14, which comprises a holding device configured to hold the at least one fiber to be cut in a defined position during cutting and after cutting.

27. A device for producing fiber preforms, the device comprising:
an unwinding station and a yarn transfer point for providing at least one fiber;
a gripper configured to grip individual or multiple fibers at a forward end thereof; and
at least one cutting device for cutting the at least one fiber, said cutting device having at least one cutting unit according to claim 14.

28. The device according to claim 27, configured to the fiber preforms being a preliminary stage in the production of fiber-reinforced plastics material components.

29. The device according to claim 27, wherein said unwinding station is one of a plurality of unwinding stations for providing multiple fibers, and said gripper is one of a plurality of grippers configured to grip in each case individual or multiple yarns or rovings at forward ends thereof, wherein each said gripper is movable to and fro along a path between a maximum position and a pick-up position, wherein the pick-up position is provided at the yarn transfer point and is closer to said unwinding station than the maximum position, wherein each said gripper has a unique maximum position and is assigned to a unique yarn transfer point and wherein said grippers are each movable individually along paths which are substantially parallel to one another.

30. The device according to claim 27, wherein said at least one cutting unit for cutting the at least one fiber, yarns or rovings is arranged between a mold and said gripper and/or said at least one cutting unit for cutting the at least one fiber yarns or rovings is arranged between a mold and the at least one yarn transfer point.
